(19) United States
(12) Patent Application Publication
(10) Pub. No.: US 2025/0094231 A1
(43) Pub. Date: Mar. 20, 2025

(54) ORCHESTRATING MULTI-STEP TASKS INVOLVING LANGUAGE MODELS

(71) Applicant: Airbnb, Inc., San Francisco, CA (US)

(72) Inventors: Adam Cheyer, Oakland, CA (US); Siamak Hodjat, Los Gatos, CA (US); Andrew Roberts, San Francisco, CA (US)

(21) Appl. No.: 18/891,385

(22) Filed: Sep. 20, 2024

Related U.S. Application Data
(60) Provisional application No. 63/539,403, filed on Sep. 20, 2023.

(51) Int. Cl. G06F 9/50

(52) U.S. Cl. CPC G06F 9/5038; G06F 2209/503

(57) ABSTRACT

A computer-implemented method includes receiving a task performance request; retrieving a stored task specification corresponding to the task performance request; generating a task implementation request including the stored task specification and an execution context; generating a task implementation corresponding to the task implementation request, the task implementation including a sequence of task execution commands; and causing execution of the sequence of task execution commands.

### CROSS-REFERENCE OF RELATED APPLICATION

This application claims the benefit of U.S. Provisional Application No. 63/539,403, filed on Sep. 20, 2023, which is incorporated herein in its entirety.

### TECHNICAL FIELD

The present disclosure generally relates to language model management, and more particularly to orchestrating multi-step tasks involving language models.

### BACKGROUND

As referred to herein, a large language model (LLM), or simply language model, is a computational model capable of language generation or other natural language processing tasks. LLMs are typically implemented using artificial neural networks and are trained to perform general-purpose language generation or to perform a more specific task using a training process.

In today's rapidly evolving technological landscape, the demand for complex task execution has surged, particularly in domains where LLMs play a pivotal role. However, as the intricacy of tasks grows, so does the challenge of orchestrating them efficiently while maintaining optimal performance, accuracy, and cost-effectiveness. Traditional approaches often struggle to handle these demands, leading to inefficiencies, duplicated efforts, and suboptimal resource utilization. Thus, the illustrative embodiments recognize that there is a need for an Architecture for Task Orchestration and Management (ATOM) framework. ATOM empowers developers to abstract the complexities of multi-step tasks, enabling high-level expression and automated execution planning. By seamlessly integrating the selection of appropriate LLM implementations for subtasks, ATOM optimizes the overall task execution process. Its ability to intelligently sequence tasks while capitalizing on parallel execution significantly enhances efficiency, while the consideration of task input/output dependencies ensures accuracy. With the potential to revolutionize the way complex tasks involving LLMs are orchestrated, ATOM stands as a crucial innovation in the pursuit of streamlined, cost-effective, and high-performance task management.

### SUMMARY

Some embodiments of the present disclosure provide a computer-implemented method for orchestrating multi-step tasks involving language models. The method includes receiving a task performance request; retrieving a stored task specification corresponding to the task performance request; generating a task implementation request comprising the stored task specification and an execution context; generating a task implementation corresponding to the task implementation request, the task implementation comprising a sequence of task execution commands; and causing execution of the sequence of task execution commands.

Some embodiments of the present disclosure provide a non-transitory computer-readable medium storing a program for orchestrating multi-step tasks involving language models. The program, when executed by a computer, configures the computer to receive a task performance request; retrieve a stored task specification corresponding to the task performance request; generate a task implementation request comprising the stored task specification and an execution context; generate a task implementation corresponding to the task implementation request, the task implementation comprising a sequence of task execution commands; and cause execution of the sequence of task execution commands.

Some embodiments of the present disclosure provide a system for orchestrating multi-step tasks involving language models. The system comprises a processor and a non-transitory computer-readable medium storing a set of instructions, which when executed by the processor, configure the processor to receive a task performance request; retrieve a stored task specification corresponding to the task performance request; generate a task implementation request comprising the stored task specification and an execution context; generate a task implementation corresponding to the task implementation request, the task implementation comprising a sequence of task execution commands; and cause execution of the sequence of task execution commands.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement orchestrating multi-step tasks involving language models, in accordance with an illustrative embodiment.

FIG. 2 is a block diagram illustrating details of a system for orchestrating multi-step tasks involving language models, in accordance with an illustrative embodiment.

FIG. 3 depicts a block diagram of an example configuration for orchestrating multi-step tasks involving language models, in accordance with an illustrative embodiment.

FIG. 4 depicts an example of orchestrating multi-step tasks involving language models, in accordance with an illustrative embodiment.

FIG. 5 depicts a flowchart of an example process of orchestrating multi-step tasks involving language models, in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by receiving a task performance request; retrieving a stored task specification corresponding to the task performance request; generating a task implementation request comprising the stored task specification and an execution context; generating a task implementation corresponding to the task implementation request, the task implementation comprising a sequence of task execution commands; and causing execution of the sequence of task execution commands.

The implementation of the Architecture for Task Orchestration and Management (ATOM) is a harmonious blend of advanced task abstraction, intelligent execution planning, and adaptive Language Model (LLM) selection. The approach revolves around transforming intricate multi-step tasks into a high-level representation, facilitating efficient execution while optimizing performance, accuracy, and cost.

ATOM's foundation lies in task abstraction, where developers express complex tasks as a series of subtasks. This abstraction hides the underlying complexities and intricacies of individual steps, enabling developers to focus on the task's high-level goals rather than implementation details. This abstraction layer not only simplifies task specification but also creates an environment conducive to adaptability and extensibility.

ATOM's intelligence shines through its execution planning mechanism. Upon receiving a task specification, ATOM analyzes the subtasks, their dependencies, and potential parallelization opportunities. The framework formulates an optimal execution plan that balances sequential execution to respect dependencies and parallel execution to exploit concurrency, thus minimizing execution time. This dynamic planning considers factors such as task priority, resource availability, and input/output relationships, ensuring efficient resource utilization and enhanced performance.

A pivotal feature of ATOM is its ability to intelligently select the most appropriate LLM implementation for each subtask. By evaluating the nature of each task, its requirements, and the available LLM variants, ATOM chooses the implementation that best matches the task's characteristics. This adaptive selection process optimizes the trade-off between performance, accuracy, and cost, contributing to overall task efficiency. This is essential in modern LLM development, because technology continually moves forward with new versions, and different vendor options, each with their own behavior and cost profiles. Use case: Members who have paid for a higher tier of service might execute the same tasks, but using a more expensive yet better quality LLM for a given subtask than lower-tier users would have access to.

Ensuring the correctness and accuracy of task execution is paramount. ATOM meticulously manages input and output dependencies among subtasks. The framework guarantees that a subtask is executed only after its prerequisites have been successfully completed, minimizing errors and maintaining data integrity throughout the execution process. In addition, ATOM assembles necessary inputs into a proper context string that serves to contextualize the prompt used to implement the call to the LLM.

ATOM's iterative approach contributes to its continuous improvement. As tasks are executed and outcomes are observed, the framework can adaptively refine its execution plans and LLM selections based on real-world performance data. This feedback loop enriches ATOM's decision-making capabilities over time, enhancing its ability to generate efficient execution plans.

The implementation approach of ATOM synergizes task abstraction, intelligent execution planning, adaptive LLM selection, and dependency management to create a dynamic and efficient orchestration framework. By addressing the complexities of orchestrating multi-step tasks involving LLMs, ATOM brings forth a novel paradigm that optimizes performance, accuracy, and cost-effectiveness, thereby revolutionizing the landscape of complex task management.

An embodiment receives a task performance request. A task performance request is a request to perform a process (optionally including multiple steps) involving one or more LLMs. A task performance request includes an optional task name, one or more required or optional parameters, an optional task context (including information such as, e.g., the user making the request, a current execution state of models available for performing the request, a user-provided input, and the like), and optional task performance requirements (e.g., details on latency, cost, and quality required for this specific invocation). One example of a complex task is the generation of a gameplan in response to a query. A gameplan is a document to aid a user through a decision-making process. Thus, an example task performance request might have a task name of initiate_decision, a user input of “what EV should I buy,” and performance requirements of high quality (referencing a predetermined threshold) and a latency of less than ten seconds.

An embodiment retrieves a stored task specification corresponding to the task performance request from a registry. A task specification includes a task name, task description, required and optional arguments (including an argument name and type for each), and optional performance requirements that all implementations of the task specification must adhere to, such as specific quality requirements, maximum latency, and the like. A task implementation includes a sequence of task execution commands. A task specification can have one or more task implementations. Implementations can themselves have other subtasks (defined using task specifications) that must be called to complete a task. The registry stores task specifications and task implementations, and responds to lookup requests for the stored task specifications and task implementations.

An embodiment generates a task execution request, including the stored and retrieved task specification and any performance requirements that were part of the task performance request.

From the task execution request, an embodiment generates a task implementation request including the stored task specification, any performance requirements that were part of the task performance request, and an execution context. An execution context describes a context in which one or more steps in the task specification are to be performed, and includes data such as the LLMs and other models that are currently available or expected to be available at a particular time, how to access a particular model, a latency of a particular model or data connection, and the like.

A planning portion of an embodiment generates a task implementation corresponding to the task implementation request. The task implementation includes a sequence of task execution commands. In particular, an embodiment responds to the task implementation request by retrieving one or more task implementations corresponding to the task implementation request from the registry. An embodiment selects one or more task implementations to execute, given any performance requirements, the current execution context, and one or more task metrics measured during execution of other task implementations. For example, there might be two stored task implementations that could be used to perform the task specification, but one uses a model that is available and the other uses a model that is not currently available, and thus an embodiment might select the implementation using the available model. An embodiment also generates an order of execution, specifying which steps in the task implementation(s) are to be executed in parallel or sequentially.

An embodiment causes execution of the sequence of task execution commands. If the task specification specifies one or more subtasks to be called, task specifications for each subtask are executed sequentially or in parallel, in a manner described herein. If an interruption occurs during task execution, other parallel task executions will continue—only the interrupted task waits to be resumed. An interrupted tasks may require user input to continue, or an embodiment uses a process described elsewhere herein to generate an alternative implementation of the task specification.

An embodiment monitors execution of the sequence of task execution commands, and measures one or more task metrics of the execution. One non-limiting example of a task metric is a latency of a particular model. An embodiment also includes a state manager that tracks state changes during execution of the sequence of task execution commands, so that if task execution is interrupted, task execution can be resumed using the last known state.

For the example initiate_decision task, there might be only one corresponding task implementation. A planning portion of an embodiment might decide that all subtasks can be executed in parallel, or choose to have the first two execute in parallel, but the third only after one of the first two completes, due to current resource constraints. One subtask might be a set_decision_title subtask, for which a planning portion of an embodiment might choose the quickest implementation, with lower, but sufficient, quality, knowing that other costly subtasks are being called. Executing the subtask causes a state change: an updated document title. Another subtask might be a set_decision_image subtask, for which there might be two stored implementations: one calls an application programming interface (API) of an image service, while another generates a new image on the fly using a generative model. A planning portion of an embodiment might choose the best implementation, based on past performance data, that meets request requirements and the current context. Executing the subtask causes a state change: adding an image to the document. Another subtask might be a set_decision_description subtask, with two stored implementations, each using a different LLM to generate the description. A planning portion of an embodiment might choose the implementation that balances quality with the time constraints required for execution. Executing the subtask causes a state change: adding a description to the document. Another subtask might be an add_decision_criteria subtask, with two stored implementations, each using a different LLM to generate the description criteria. A planning portion of an embodiment might choose the implementation that balances quality with the time constraints required for execution. Executing the subtask causes a state change: adding decision criteria to the document. Each of the preceding subtasks can execute in parallel. Another subtask might be an add_decision_options subtask, with inputs from the decision description and decision criteria already added and two stored implementations, one calling an LLM and another performing a web search, with a further subtask called to perform data extraction from results of the search. A planning portion of an embodiment might choose the second implementation, which fails, and thus the portion selects the first implementation instead.

An embodiment's task planning can learn and adapt from past executions. For example, tasks can be impacted by general performance metrics such as how long specific tasks take to complete, resources required to execute a task, the accuracy or quality of results, or an estimate of overall cost of execution. Tasks can also be impacted by resource availability. For example, one or more tasks which are planned to be executed in parallel, might fail to run due to restricted resources. Task execution can also be context-dependent, as tasks executed upstream can impact later subtasks, the requirements of specific task requests, or by other tasks currently being executed. An embodiment's task planning is configurable with available resources, and then can learn from task metric data, using both offline and online processing. For example, an embodiment might decide to execute certain tasks sequentially in a current execution context, even though the tasks could be performed in parallel. An embodiment also determines when alternate implementations of a task specification (performing the same function but with different performance tradeoffs) are to be executed. One embodiment includes multiple implementations of a task specification, where each uses different LLMs, or makes a different number of LLM calls to perform the same function. An embodiment learns improved LLM selection from the performance characteristics of one or more completed tasks, in the context of requirements for a specific task performance request.

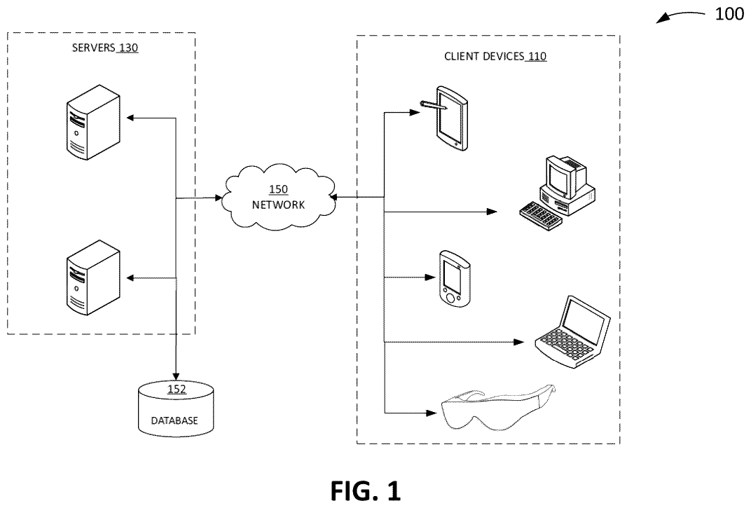

FIG. 1 illustrates a network architecture 100 used to implement orchestrating multi-step tasks involving language models, in accordance with an illustrative embodiment. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

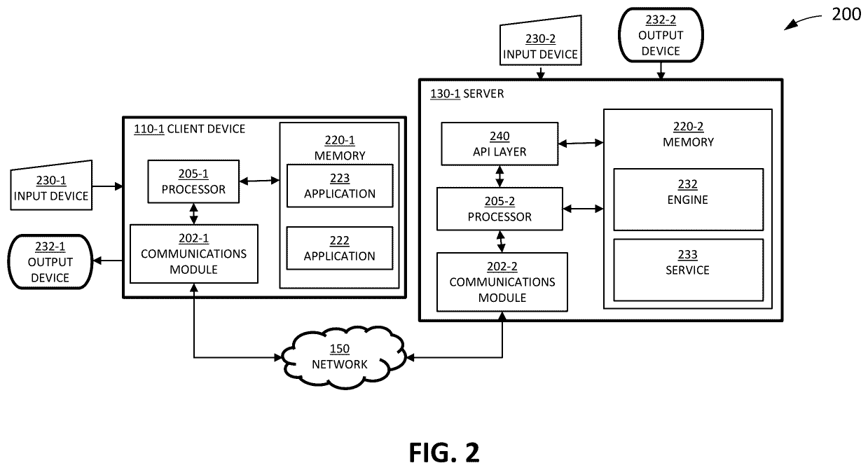

FIG. 2 is a block diagram illustrating details of a system 200 for orchestrating multi-step tasks involving language models, in accordance with an illustrative embodiment. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222 implementing clothing-specific models for generating a clothed avatar. Application 222 is configured to execute on client device 110-1 and couple with input device 230-1 and output device 232-1. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide clothing-specific models for generating a clothed avatar. The application 223 may communicate with service 233 through API layer 240, for example.

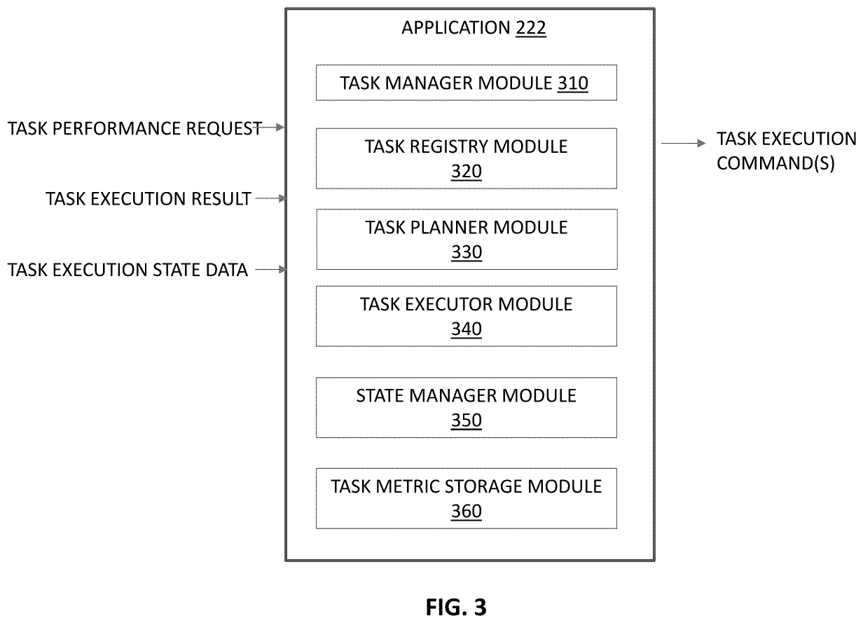

FIG. 3 depicts a block diagram of orchestrating multi-step tasks involving language models, in accordance with an illustrative embodiment. Application 222 is the same as application 222 in FIG. 2.

Task manager module 310 receives a task performance request. A task performance request is a request to perform a process (optionally including multiple steps) involving one or more LLMs. A task performance request includes an optional task name, one or more required or optional parameters, an optional task context (including information such as, e.g., the user making the request, a current execution state of models available for performance the request, a user-provided input, and the like), and optional task performance requirements (e.g., details on latency, cost, and quality required for this specific invocation). One example of a complex task is the generation of a gameplan in response to a query. A gameplan is a document to aid a user through a decision-making process. Thus, an example task performance request might have a task name of initiate_decision, a user input of “what EV should I buy”, and performance requirements of high quality (referencing a predetermined threshold) and a latency of less than ten seconds.

Task manager module 310 retrieves a stored task specification corresponding to the task performance request from a registry maintained by task registry module 320. A task specification includes a task name, task description, required and optional arguments (including an argument name and type for each), and optional performance requirements that all implementations of the task specification must adhere to, such as specific quality requirements, maximum latency, and the like. A task implementation includes a sequence of task execution commands. A task specification can have one or more task implementations. Implementations can themselves have other subtasks (defined using task specifications) that must be called to complete a task. Task registry module 320 stores task specifications and task implementations, and responds to lookup requests for the stored task specifications and task implementations.

Task manager module 310 generates a task execution request, including the stored and retrieved task specification and any performance requirements that were part of the task performance request.

From the task execution request, task execution module 340 generates a task implementation request including the stored task specification, any performance requirements that were part of the task performance request, and an execution context. An execution context describes a context in which one or more steps in the task specification are to be performed, and includes data such as the LLMs and other models that are currently available or expected to be available at a particular time, how to access a particular model, a latency of a particular model or data connection, and the like.

Task planner module 330 generates a task implementation corresponding to the task implementation request. The task implementation includes a sequence of task execution commands. In particular, module 330 responds to the task implementation request by retrieving one or more task implementations corresponding to the task implementation request from the registry maintained by module 320. Module 330 selects one or more task implementations to execute, given any performance requirements, the current execution context, and one or more task metrics measured during execution of other task implementations. For example, there might be two stored task implementations that could be used to perform the task specification, but one uses a model that is available and the other uses a model that is not currently available, and thus an embodiment might select the implementation using the available model. Module 330 also generates an order of execution, specifying which steps in the task implementation(s) are to be executed in parallel or sequentially.

Module 340 causes execution of the sequence of task execution commands. If the task specification specifies one or more subtasks to be called, task specifications for each subtask are executed sequentially or in parallel, in a manner described herein. If an interruption occurs during task execution, other parallel task executions will continue—only the interrupted task waits to be resumed. An interrupted task may require user input to continue, or application 222 uses a process described elsewhere herein to generate an alternative implementation of the task specification.

Task metric storage module 360 monitors execution of the sequence of task execution commands, and measures one or more task metrics of the execution. One non-limiting example of a task metric is a latency of a particular model. State manager module 350 tracks state changes during execution of the sequence of task execution commands, so that if task execution is interrupted, task execution can be resumed using the last known state.

For the example initiate_decision task, there might be only one corresponding task implementation. Module 330 might decide that all subtasks can be executed in parallel, or choose to have the first two execute in parallel, but the third only after one of the first two completes, due to current resource constraints. One subtask might be a set_decision_title subtask, for which module 330 might choose the quickest implementation, with lower, but sufficient, quality, knowing that other costly subtasks are being called. Executing the subtask causes a state change: an updated document title. Another subtask might be a set_decision_image subtask, for which there might be two stored implementations: one calls an application programming interface (API) of an image service, while another generates a new image on the fly using a generative model. Module 330 might choose the best implementation, based on past performance data, that meets request requirements and the current context. Executing the subtask causes a state change: adding an image to the document. Another subtask might be a set_decision_description subtask, with two stored implementations, each using a different LLM to generate the description. Module 330 might choose the implementation that balances quality with the time constraints required for execution. Executing the subtask causes a state change: adding a description to the document. Another subtask might be an add_decision_criteria subtask, with two stored implementations, each using a different LLM to generate the description criteria. Module 330 might choose the implementation that balances quality with the time constraints required for execution. Executing the subtask causes a state change: adding decision criteria to the document. Each of the preceding subtasks can execute in parallel. Another subtask might be an add_decision_options subtask, with inputs from the decision description and decision criteria already added and two stored implementations, one calling an LLM and another performing a web search, with a further subtask called to perform data extraction from results of the search. Module 330 might choose the second implementation, which fails, and thus the portion selects the first implementation instead.

Application 222′s task planning can learn and adapt from past executions. For example, tasks can be impacted by general performance metrics such as how long specific tasks take to complete, resources required to execute a task, the accuracy or quality of results, or an estimate of overall cost of execution. Tasks can also be impacted by resource availability. For example, one or more tasks which are planned to be executed in parallel, might fail to run due to restricted resources. Task execution can also be context-dependent, as tasks executed upstream can impact later subtasks, the requirements of specific task requests, or by other tasks currently being executed. Application 222′s task planning is configurable with available resources, and then can learn from task metric data, using both offline and online processing. For example, application 222 might decide to execute certain tasks sequentially in a current execution context, even though the tasks could be performed in parallel. Application 222 also determines when alternate implementations of a task specification (performing the same function but with different performance tradeoffs) are to be executed. One implementation of application 222 includes multiple implementations of a task specification, where each uses different LLMs, or makes a different number of LLM calls to perform the same function. Application 222 learns improved LLM selection from the performance characteristics of one or more completed tasks, in the context of requirements for a specific task performance request.

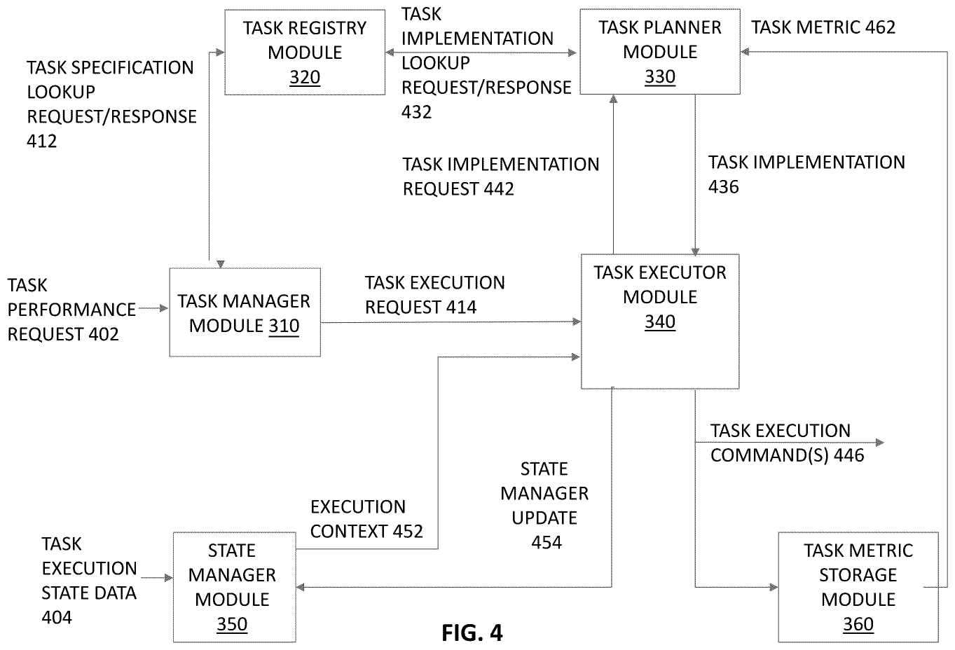

FIG. 4 depicts an example of orchestrating multi-step tasks involving language models, in accordance with an illustrative embodiment. The example can be executed using application 222 in FIG. 2. Task manager module 310, task registry module 320, task planner module 330, task execution module 340, state manager module 350, and task metric storage module 360 are the same as task manager module 310, task registry module 320, task planner module 330, task execution module 340, state manager module 350, and task metric storage module 360 in FIG. 3.

Task manager module 310 receives task performance request 402. Using task specification lookup request/response 412, task manager module 310 retrieves a stored task specification corresponding to task performance request 402 from a registry maintained by task registry module 320. In response, task manager module 310 generates task execution request 414, including stored and retrieved task specification 412 and any performance requirements that were part of the task performance request.

From task execution request 414, task execution module 340 generates task implementation request 442, including stored and retrieved task specification 412, any performance requirements that were part of task performance request 402. and execution context 452. Task planner module 330 responds to task implementation request 442 by (using task implementation lookup request/response 432) retrieving one or more task implementations corresponding to task implementation request 442 from the registry maintained by module 320. Module 330 generates task implementation 436: one or more task implementations to execute, given any performance requirements, execution context 452, and task metric 462 (measured during execution of other task implementations), as well as an order of execution. Module 340 causes execution of task execution commands 446, generating state manager update 454 as commands 446 cause one or more state changes.

Task metric storage module 360 monitors execution of the sequence of task execution commands, and measures one or more task metrics of the execution, including task metric 462. State manager module 350 tracks state changes during execution of the sequence of task execution commands, including task execution state data 404, generating execution context 452.

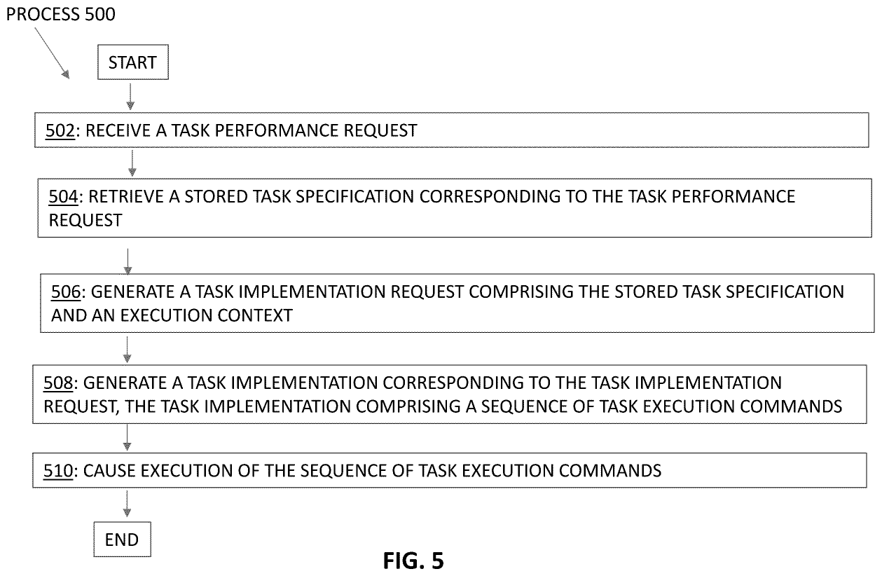

FIG. 5 depicts a flowchart of an example process of orchestrating multi-step tasks involving language models, in accordance with an illustrative embodiment. Process 500 can be implemented in application 222 in FIG. 2.

At block 502, the process receives a task performance request. At block 504, the process retrieves a stored task specification corresponding to the task performance request. At block 506, the process generates a task implementation request comprising the stored task specification and an execution context. At block 508, the process generates a task implementation corresponding to the task implementation request, the task implementation comprising a sequence of task execution commands. At block 510, the process causes execution of the sequence of task execution commands. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein, may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
receiving a task performance request;
retrieving a stored task specification corresponding to the task performance request;
generating a task implementation request comprising the stored task specification and an execution context;
generating a task implementation corresponding to the task implementation request, the task implementation comprising a sequence of task execution commands; and
causing execution of the sequence of task execution commands.

2. The computer-implemented method of claim 1, wherein the task performance request comprises a task context.

3. The computer-implemented method of claim 1, wherein the task performance request comprises a performance requirement.

4. The computer-implemented method of claim 3, wherein the performance requirement comprises a latency maximum.

5. The computer-implemented method of claim 1, wherein the stored task specification comprises a plurality of subtasks.

6. The computer-implemented method of claim 1, wherein the task implementation comprises a first task execution command executed in parallel with a second task execution command.

7. The computer-implemented method of claim 1, wherein the task implementation comprises a command to execute a large language model (LLM).

8. The computer-implemented method of claim 7, wherein the execution context comprises an availability of the LLM.

9. A non-transitory computer-readable medium storing a program, which when executed by a computer, configures the computer to:
receive a task performance request;
retrieve a stored task specification corresponding to the task performance request;
generate a task implementation request comprising the stored task specification and an execution context;
generate a task implementation corresponding to the task implementation request, the task implementation comprising a sequence of task execution commands; and
cause execution of the sequence of task execution commands.

10. The non-transitory computer-readable medium of claim 9, wherein the task performance request comprises a task context.

11. The non-transitory computer-readable medium of claim 9, wherein the task performance request comprises a performance requirement.

12. The non-transitory computer-readable medium of claim 11, wherein the performance requirement comprises a latency maximum.

13. The non-transitory computer-readable medium of claim 9, wherein the stored task specification comprises a plurality of subtasks.

14. The non-transitory computer-readable medium of claim 9, wherein the task implementation comprises a first task execution command executed in parallel with a second task execution command.

15. The non-transitory computer-readable medium of claim 9, wherein the task implementation comprises a command to execute a large language model (LLM).

16. The non-transitory computer-readable medium of claim 15, wherein the execution context comprises an availability of the LLM.

17. A system comprising:
a processor; and
a non-transitory computer-readable medium storing a set of instructions, which when executed by the processor, configure the system to:
receive a task performance request;
retrieve a stored task specification corresponding to the task performance request;
generate a task implementation request comprising the stored task specification and an execution context;
generate a task implementation corresponding to the task implementation request, the task implementation comprising a sequence of task execution commands; and
cause execution of the sequence of task execution commands.

18. The system of claim 17, wherein the task performance request comprises a task context.

19. The system of claim 17, wherein the task performance request comprises a performance requirement.

20. The system of claim 19, wherein the performance requirement comprises a latency maximum.
